(19) United States
(12) Patent Application Publication
(10) Pub. No.: US 2025/0011200 A1
(43) Pub. Date: Jan. 9, 2025

(54) PHOTOELECTROCHEMICAL (PEC) SYSTEM AND METHOD, AND REDOX-FUNCTIONALIZED PHOTOELECTRODE FOR SEPARATION OF IONS

(71) Applicant: The Board of Trustees of the University of Illinois, Urbana, IL (US)

(72) Inventors: Xiao SU, Champaign, IL (US); Kihyun CHO, Savoy, IL (US)

(21) Appl. No.: 18/760,457

(22) Filed: Jul. 1, 2024

Related U.S. Application Data
(60) Provisional application No. 63/525,021, filed on Jul. 5, 2023.

(51) Int. Cl. C02F 1/469; C02F 101/10; C02F 101/20; C02F 101/22; C02F 101/34

(52) U.S. Cl. CPC C02F 1/469; C02F 2101/103; C02F 2101/20; C02F 2101/22; C02F 2101/34; C02F 2201/46

(57) ABSTRACT

A redox-functionalized photoelectrode includes (a) a photoactive structure comprising a semiconductor and (b) a redox polymer coated on the photoactive structure, where a valence band potential of the semiconductor is more positive than a redox potential of the redox polymer. A photoelectrochemical method for separating targeted ionic species from a liquid includes exposing a redox-functionalized photoelectrode, which includes a photoactive structure comprising a semiconductor and a redox polymer comprising a redox-active group coated on the photoactive structure, to a liquid to be treated. During the exposure, the redox-functionalized photoelectrode is illuminated with light having a wavelength greater than a bandgap of the semiconductor. Oxidation of the redox-active group occurs, and targeted ionic species are removed from the liquid by adsorption onto the redox polymer.

### RELATED APPLICATION

The present patent document claims the benefit of priority under 35 U.S.C. 119(e) to U.S. Provisional Patent Application No. 63/525,021, which was filed on Jul. 5, 2023, and is hereby incorporated by reference in its entirety.

### STATEMENT REGARDING FEDERALLY SPONSORED RESEARCH OR DEVELOPMENT

This invention was made with government support under contract number DE-S00021409 awarded by the Department of Energy. The government has certain rights in the invention.

### TECHNICAL FIELD

This disclosure relates generally to electrochemical separation technology and more particularly to an electrode, system and method for photoelectrochemical separation.

### BACKGROUND

Electrochemical separations have been proposed as an energy-efficient and modular technology that can contribute to the decarbonization of manufacturing and environmental processes. Advances in redox-mediated electrosorption techniques, particularly with redox-polymers, can enable high separation performance for target ions in multicomponent mixtures and in dilute concentrations due to their remarkable selectivity, tunability, and reversible adsorption/desorption. Redox-electrosorption has extended applicability for ion-selective recovery in industrial wastewater treatment, mining recovery, and environmental remediation. However, current global electrical energy is still predominantly derived from non-renewable fossil-fuel-based sources, which raises questions about the long-term sustainability of electrochemical processes, including electrochemical separations.

### BRIEF DESCRIPTION OF THE DRAWINGS

The embodiments may be better understood with reference to the following drawings and description. The components in the figures are not necessarily to scale.

FIGS. 1A and 1B are schematics of a photoactive structure comprising semiconducting nanorods before (1A) and after (11B) coating with a redox polymer to form an exemplary redox-functionalized photoelectrode.

FIG. 1C is a close-up view of the redox-functionalized photoelectrode shown in FIG. 1B while exposed to light, illustrating adsorption of oxyanions from a liquid (e.g., an industrial waste stream).

FIG. 2 is a schematic of a photoelectrochemical system including a redox-functionalized photoelectrode and further comprising several optional features, as described below.

FIG. 3A shows adsorption kinetics for MoO₄²⁻ under no bias condition utilizing exemplary redox-functionalized photoelectrodes, specifically, (PVF-CNT)/TiO₂ photoelectrodes.

FIG. 3B shows potential-dependent uptake of MoO₄²⁻ by the redox-functionalized photoelectrodes for 90 min in a 2 mM Na₂MoO₄ solution, where NB refers to no bias condition.

FIG. 4 shows uptake of MoO₄²⁻, CrO₄²⁻, and HAsO₄²⁻ with a competing ion at 0.3 V vs. saturated calomel electrode (SCE) utilizing the redox-functionalized photoelectrodes, where separation was carried out for 2 mM of heavy metal oxyanions in a 20 mM NaClO₄ solution and the symbols indicate the uptake capacity of PVF-CNT-coated electrodes from previous electrochemical separation results at 0.8 V vs. Ag/AgCl (0.75 V vs. SCE); in addition, separation of 1 ppm HAsO₄²⁻ in secondary wastewater solution collected from the Sanitary District of Decatur in Illinois was carried out.

FIG. 5 shows regeneration efficiency of the redox-functionalized photoelectrodes with and without a regeneration potential; the efficiency was traced after separation of 2 mM MoO₄²⁻ at 0.3 V vs. SCE under illumination.

FIG. 6A shows a schematic of homogeneous oxidation of BTMAP-Fc in an aqueous electrolyte with a semiconducting nanorod-based (TiO₂ in this example) photoelectrode.

FIG. 6B shows a representative scanning electron microscope (SEM) image showing a top view of an array of TiO₂ nanorods.

FIG. 7 shows cyclic voltammetry (CV) curves of a TiO₂ nanorod electrode with a scan rate of 0.02 V/s in the salt bridge cell with 5 mM (Bis[3-(trimethylammonio)propyl] ferrocene (BTMAP-Fc) and 100 mM Na₂SO₄ in deionized (DI) water under dark and illumination.

FIG. 8 shows absorption spectra of the BTMAP-Fc solution with respect to reaction time with light irradiation to the TiO₂ nanorod electrode without applying a bias voltage.

FIG. 9 shows potential-dependent rate constant of BTMAP-Fc oxidation under dark and illumination.

FIGS. 10A-10D show current densities and potentials of an exemplary photoelectrode and a counter electrode, and cell voltage recorded simultaneously without applying a bias voltage under dark and illumination, respectively, where blips at every 60 min were caused by extraction of the BTMAP-Fc solution for UV-Vis spectroscopy.

FIG. 11 illustrates a proposed mechanism for the photoelectrochemically-activated redox process of BTMAP-Fc on an exemplary TiO₂ nanorod electrode, constructed based on the measurement results.

FIG. 12 shows applied bias photon-to-current conversion efficiency (ABPE, η) of redox-functionalized photoelectrodes according to this disclosure, where η_{OER} was calculated using a linear sweep voltammetry (LSV) curve (with an assumption of 100% Faradaic efficiency of oxygen evolution reaction (OER), η_{OER+SR} (the ABPE for OER and separation reaction (SR) together) and η_{SR} (the ABPE for separation reaction (SR)) were calculated using the steady-state currents from chronoamperometry (CA) results and the Faradaic efficiency for the separation reaction (SR) shown in FIG. 3B.

FIGS. 13A-13B show potentials of a working electrode (WE) and a counter electrode (CE) of a PEC cell were traced during chronopotentiometry (CP) measurements under (13A) dark and (13B) illumination; in these and the following figures, NB, TNR, and CP refer to no bias condition, TiO₂ NR, and carbon paper electrodes, respectively.

FIG. 14 shows cell voltages of the PEC and EC cells during the CP measurements, and the cell voltage of the PEC cell under no bias illumination condition is also presented; in the EC cell, the working electrode was prepared by drop casting of PVF-CNT on a carbon paper electrode.

FIG. 15 shows a comparison of energy consumption of the PEC and EC cells; all the CP measurements were performed at I=0.5 mA/cm² for separation of 2 mM MoO₄²⁻ in DI water for 30 min.

### DETAILED DESCRIPTION

Described in this disclosure is a redox-mediated photoelectrochemical separation method and system for selective adsorption of ionic waste components from liquid streams. The photoelectrochemical system and method rely on a redox-functionalized photoelectrode which is constructed from a suitably selected semiconductor and redox polymer and may be activated by light to achieve redox-mediated selective electrosorption. In the examples below, an exemplary photoelectrochemical system based on a polyvinyl ferrocene (PVF)-coated titanium dioxide (TiO₂) photoelectrode is shown to be able to separate heavy metal oxyanions without electrical energy and, when a bias voltage is applied, to achieve separation at lower voltages than traditional electrochemical cells. For example, at 0.3 V vs. saturated calomel electrode (SCE), a 124 mg/g MoO₄²⁻ uptake was achieved, which is comparable to the performance of a traditional electrochemical cell at 0.75 V vs. SCE. Thus, the photoelectrochemical systems described in this disclosure not only can generate energy for spontaneous redox-separations, but also, when coupled with an external power source, can reduce electrical energy consumption for separation processes by over 50% compared to traditional electrochemical cells.

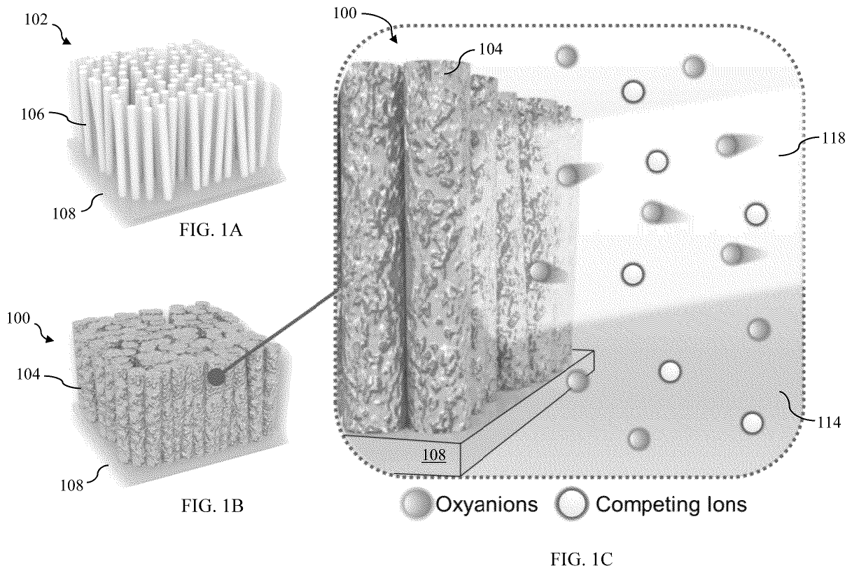

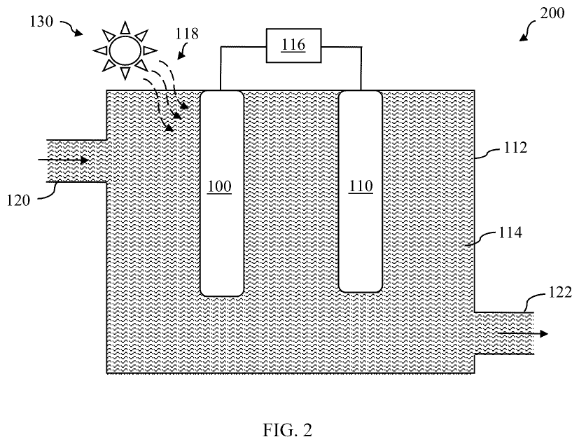

Referring to FIGS. 1A-1C, the redox-functionalized photoelectrode 100 includes a photoactive structure 102 comprising a semiconductor 106, and a redox polymer 104 comprising a redox active group coated on the photoactive structure 102. The semiconductor 106 and the redox polymer 104 are selected such that a valence band potential of the semiconductor is more positive than a redox potential of the redox polymer 104. If this requirement is met, then oxidation of the redox polymer 104, or more particularly, oxidation of the redox active group (e.g., ferrocene) of the redox polymer 104, may occur when the semiconductor 106 absorbs light. More specifically, when the semiconductor 106 absorbs above-bandgap photons (that is, photons having an energy higher than the bandgap of the semiconductor), electrons are excited from the valence band of the semiconductor 106 into the conduction band, such that electrical energy comparable to the bandgap is produced and holes are generated in the valence band. When the valence band potential is more positive than the redox potential of the redox active group, the generated holes can oxidize the redox active group to take on a positive charge, which attracts targeted anionic species from a waste stream for adsorption by the redox polymer 104. The waste stream, or liquid to be treated, may comprise industrial wastewater, e.g., from semiconductor, steel, mining, and/or chemical manufacturing, or municipal wastewater, for example. The liquid may include anionic species such as inorganic oxyanions (MO₄²⁻, M=metal), in particular heavy metal oxyanions, such as MoO₄²⁻, HAsO₄²⁻, or CrO₄²⁻, and/or carboxylates, such as lactic acid, succinic acid and/or acetic acid.

The photoactive structure 102 comprising the semiconductor 106 may have a non-planar morphology, as shown in FIG. 1A. For example, the photoactive structure 102 may include surface protrusions, surface indentations, and/or surface roughness. In some examples, the photoactive structure 102 may comprise rods (as shown), wires, fibers, pellets, beads, and/or particles. If at least one dimension of the photoactive structure 102 is nanoscale in size (e.g., from 1-100 nm), the photoactive structure 102 may be described as comprising nanorods, nanofibers, nanowires, nanopellets, nanobeads and/or nanoparticles. In other examples, the photoactive structure 102 may have the form of a porous film, porous scaffold (e.g., an aerogel), and/or permeable membrane. Common to these semiconducting structures and morphologies is a high surface area-to-volume ratio, which allows the redox polymer 104 to be coated over a relatively large area for adsorption of the ionic waste components. The redox polymer 104 may be conformally coated on the photoactive structure 102 to maximize the surface area available for electrosorption.

Some or all of the photoactive structure 102 may be coated by the redox polymer 104. It is preferable that all parts of the photoactive structure 102 that might otherwise come into contact with the fluid 114 to be treated (e.g., water) are coated with the redox polymer 104, as uncoated portions of the electroactive structure 102 may induce water splitting during the photoelectrochemical process. The redox polymer 104 may take the form of an optically translucent film, where at least 50% of impinging light passes through, or an optically transparent film, where at least 80% and up to 100% of light passes through. To promote optical transparency, the redox polymer 104 may have a coating thickness of no greater than 1000 nm, and more typically in a range from 10 to 300 nm.

The redox polymer 104 may comprise a metallopolymer. Suitable examples may include polyvinyl ferrocene (PVF), poly ferrocenylsilane (PFS), (2,2,6,6-tetramethylpiperidin-1-yl)oxyl (TEMPO) polymer, polyferrocenylmethyl methacrylate (PFMAA), and/or poly(3-ferrocenylpropyl methacrylamide) (PFPMAm). The redox polymer 104 may be selective toward inorganic oxyanions (MO₄²⁻, M=metal) and carboxylates (e.g., include lactic acid, succinic acid and/or acetic acid). The redox active group or species can undergo oxidation and reduction, and may comprise ferrocene, an organometallic compound having the chemical formula Fe(C₅H₅)₂. Ferrocene undergoes a one-electron oxidation at around +0.4 V versus a saturated calomel electrode (SCE), becoming ferrocenium. The redox polymer 104 may be part of a polymer composite including an electrically conductive additive, such as carbon nanotubes or another form of carbon. In the examples described below, surfaces of the carbon nanotubes are functionalized with the redox polymer 104 to promote a uniform distribution of the redox polymer 104, high mechanical robustness, and enhanced surface area.

The photoactive structure 102 comprising the semiconductor 106 may be self-supporting, e.g., in the case of a porous scaffold or permeable membrane. Alternatively, the photoelectrode 100 may further include a solid substrate 108, as illustrated in FIG. 1C, which supports the photoactive structure 102. The substrate 108 may be electrically conductive or may include an electrically conductive layer or portion that contacts the semiconductor 106. In one example, the substrate 108 may take the form of a metal plate comprising titanium, copper or stainless steel. In other examples, it may be beneficial for the substrate 108 to be optically transparent. In such a case, the substrate 108 may comprise glass coated with a transparent conductive film, such as fluorine-doped tin oxide (FTO), indium-doped tin oxide (ITO), or aluminum-doped zinc oxide (AZO).

The semiconductor 106 may have a single-crystalline or polycrystalline structure. Broadly speaking, the semiconductor 106 may comprise titanium oxide (TiO₂), zinc oxide (ZnO), bismuth vanadate (BiVO₄), iron oxide (Fe₂O₃), cadmium selenide (CdSe), cadmium sulfide (CdS), zinc selenide (ZnSe), zinc sulfide (ZnS), indium phosphide (InP), gallium phosphide (GaP), moly disulfide (MoS₂), tungsten oxide (WO₃), silicon (Si), and/or tantalum nitride (Ta₃N₅).

More particularly, combinations of semiconductors 106 and redox polymers 104 believed to be suitable for the redox-mediated electrosorption process described in this disclosure include BiVO₄, Fe₂O₃, CdS, ZnO, and TiO₂ (semiconductors) and PVF, PFMAA and PFPMAm (redox polymers), due to the relationship between the valence band potentials of the semiconductors 106 and the redox potentials of the polymers 104. More specifically, the redox potentials of the above-mentioned polymers lie in a range from 0.3-0.5 V vs. SCE at pH 7, and the valence band potentials of the semiconductors are more positive with values of ˜1.7-1.9 V for BiVO₄, ˜1.8-2.0 V for Fe₂O₃, ˜1.1-1.3 V for CdS, ˜2.2-2.3 V for ZnO, and ˜2.3-2.4 V for TiO₂ vs. SCE at pH 7.

Referring now to FIG. 2, a photoelectrochemical system 200 for separation of an ionic species from a liquid to be treated 114 may include a redox-functionalized photoelectrode 100 as described above; that is, a photoelectrode 100 including (a) a photoactive structure 102 comprising a semiconductor and (b) a redox polymer 104 comprising a redox active group coated on the photoactive structure 102. To facilitate redox mediation of the process, the valence band potential of the semiconductor may be more positive than the redox potential of the redox active group. The system 200 includes a light source 130, which may be the sun (that is, natural light or solar radiation) or an artificial light source, as discussed below. In some examples, the system 200 may include a counter electrode 110 spaced apart from the photoelectrode 100. The counter electrode 110 may take the form of a conventional metal (e.g., platinum) electrode that resists degradation during the photoelectrochemical treatment. The photoelectrochemical system 200 may also or alternatively include a vessel 112 configured to hold the liquid 114 to be treated (e.g., for a batch process). Alternatively, the vessel 112 may be configured such that the liquid 114 to be treated may be flowed through the vessel 112. For example, the vessel 112 may include an inlet 120 and an outlet 122 as illustrated for introduction and removal of the liquid 114, respectively. Alternatively, it is contemplated that the photoelectrochemical system 200 may be configured for fluid flow without requiring a containment vessel 112; e.g., the redox-functionalized photoelectrode 100 may be inserted directly into a waste stream with or without the counter electrode 110. In some examples, the system 200 may include a voltage source 116 electrically connected to the redox-functionalized photoelectrode 100 and the counter electrode 110 to provide the option of supplementing the photoelectrochemical process with a bias voltage. The photoactive structure 102 may be directly electrically connected to the voltage source 116, particularly in a situation where the photoactive structure 102 is self-supporting and does not require a substrate. Alternatively, the conductive substrate (e.g., the metal plate or conductive oxide-coated glass) 108 on which the photoactive structure 102 is supported may be electrically connected to the voltage source 116.

A photoelectrochemical method for separating ionic species from a liquid is now described in reference to FIG. 1C. The method includes exposing a redox-functionalized photoelectrode 100 to a liquid 114 to be treated, which may be a waste stream from, for example, semiconductor, steel, mining, and/or chemical manufacturing. As described above, the redox-functionalized photoelectrode 100 includes (a) a photoactive structure 102 comprising a semiconductor 106 and (b) a redox polymer 104 coated on the photoactive structure 102, where the redox polymer 104 comprises a redox-active group or species. The redox-functionalized photoelectrode 100, including the photoactive structure 102, semiconductor 106 and redox polymer 104, may have any of the characteristics or properties described elsewhere in this disclosure. Advantageously, the valence band potential of the semiconductor 106 may be more positive than the redox potential of the redox active group.

During the exposure of the redox-functionalized photoelectrode 100 to the liquid 114 to be treated, the photoactive structure 102 may be illuminated with light 118 having a wavelength greater than the bandgap of the semiconductor 106. Consequently, oxidation of the redox-active group may occur and targeted ionic species (e.g., the oxyanions shown in FIG. 1C) may be selectively removed from the liquid 114 by adsorption onto the redox polymer 104.

The illumination may involve passing light 118 through the redox polymer 104, which, as indicated above, may be light translucent or light transparent. Also or alternatively, the illumination may entail passing light 118 through a transparent substrate 108 (e.g., glass coated with a transparent conductive oxide), which may support the photoactive structure 102 and also define the “back” of the photoelectrode 100. In such an example, some or all of the light 118 reaching the photoactive structure 102 may not pass through the redox polymer 104. The light 118 with which the photoactive structure 102 is illuminated may comprise solar radiation, particularly if the method is implemented outdoors. In other examples, the light 118 may comprise artificial light. For example, a solar radiation simulator, an artificial light source configured to substantially match the spectral distribution and intensity of solar radiation, may be used. The photoactive structure 102 may be illuminated with the light 118 for a time duration sufficient to achieve saturation of the adsorption. As shown from the examples below, uptake of the targeted ionic species may be at least about 10 mg/g after illumination for 30 minutes, or after illumination for 60 minutes.

Exposing the redox-functionalized photoelectrode 100 to the liquid 114 may entail immersing the photoelectrode in the liquid 114, e.g., in a batch process. Alternatively, exposing the photoelectrode 100 to the liquid 114 may comprise positioning the photoelectrode 100 in a flow of the liquid 100 in a continuous process, as illustrated in FIG. 2. The photoelectrode 100 may be positioned in a flow-through configuration with respect to flow of the liquid 114, where the electrical current is parallel to the flow of the liquid 114, or in a flow-by configuration with respect to flow of the liquid 114, where the electrical current is perpendicular to the fluid flow. To enhance adsorption, the flow may be cycled past the photoelectrode multiple times (e.g., in a loop) in the flow-by or flow-through configuration. A pump may be employed to control the flow rate of the liquid 114 to be treated.

It may be advantageous to apply a bias voltage to the redox-functionalized photoelectrode 100 during illumination to boost the photoelectrochemical effect and increase the adsorption efficiency. Suitable bias voltages may depend on the semiconductor but typically lie in a range from about 0 to 2.5 V for two electrode system, or −0.3 to 1.5 V vs SCE at pH 7 for three-electrode system. Experiments below demonstrate that, when a bias voltage is applied during illumination, redox-functionalized photoelectrodes can exhibit a higher uptake capacity than when illuminated without an applied bias voltage. Alternatively, to avoid using a non-renewable energy source, a bias voltage may not be applied.

The method may further include regenerating the redox-functionalized photoelectrode 100 after electrosorption is deemed complete. Regeneration may entail releasing the adsorbed ionic species by exposing the photoelectrode 100 to dark (e.g., by halting the illumination) and/or by partially or completely reversing the bias voltage that can reduce ferrocenium to ferrocene. In a three-electrode system, ideally the potential for regeneration is more negative than the redox potential of the redox polymer, e.g., for PVF, <˜0.4 V vs. SCE at pH 7.

Fabrication of the redox-functionalized photoelectrode 100 may entail coating the redox polymer 104 onto the photoactive structure 102 using deposition methods known in the art, such as dip coating, spin coating, drop casting, spray coating, and electrodeposition. The photoactive structure 102 may be made using methods known in the art for fabricating textured or roughened semiconductor surfaces, high-aspect ratio semiconductor structures, semiconductor particles, and/or porous semiconductor bodies.

### Examples

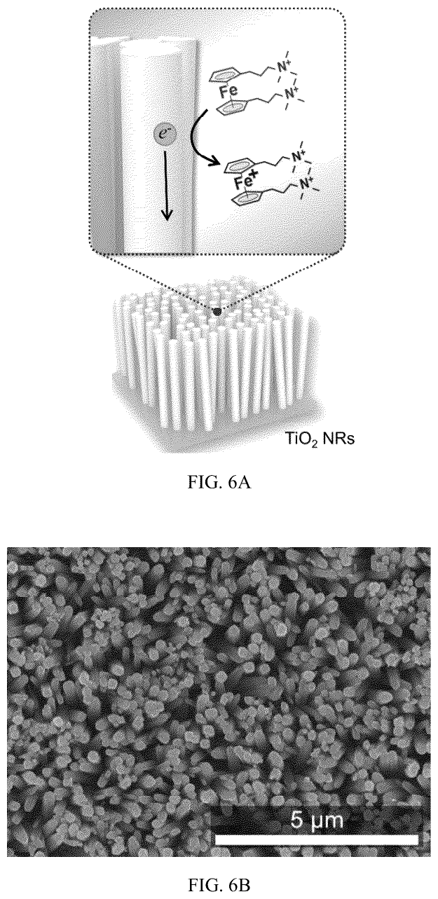

A photoelectrochemical (PEC) redox-mediated ion separation system was demonstrated for the first time. To realize proof-of-concept light-driven redox reactions for ion capture using solar energy, vertically standing TiO₂ nanorods (NRs) were grown on fluorine-doped tin oxide (FTO) substrates (see FIGS. 6A and 6B). TiO₂ is an environmental friendly semiconductor with a relative photostability to photo-corrosion so that secondary contamination by its decomposition can be minimized. Then, polyvinyl ferrocene (PVF)-functionalized carbon nanotubes (CNTs) (PVF-CNT) were coated on TiO₂ NR arrays for redox-mediated electrosorption of MoO₄²⁻, HASO₄²⁻, and CrO₄²⁻ (see FIG. 1C). Molybdenum, arsenic, and chromium were selected due to their relevance as major waste components from semiconductor, steel, mining, and chemical industries. It is noted that the terms nanorod electrode, NR electrode, and photoelectrode may be used interchangeably below and throughout this disclosure.

The redox-mediated PEC system not only induced spontaneous redox-reactions that enabled heavy metal oxyanion capture with zero electrical energy but also achieved an uptake capacity comparable with that of the EC system, while having significantly decreased electrical energy consumption by 51.4%. The redox reaction of the water-soluble ferrocene (Fc) (Bis[3-(trimethylammonio)propyl] ferrocene (BTMAP-Fc)) reveals that the Fc oxidation reaction to ferrocenium (Fc⁺) with the TiO₂ NR electrodes happened spontaneously without electrical energy, and also leads to the lower bias voltage for the oxidation reaction than those under dark, providing evidence for the solar-driven activation of the redox mediators. Finally, it is shown that PEC redox-separations can efficiently remove dilute arsenate from real wastewater matrices, as a proof-of-concept for the applicability of these systems for wastewater treatment and environmental remediation.

### Heterogeneous Photoelectrochemical Separation of Heavy Metal Oxyanions

The PEC separation of heavy metal oxyanions was performed by integrating TiO₂ NR arrays with the EC Faradaic electrosorption systems, with PVF redox-metallopolymers as the active electrosorbent material due to their exceptional capability for charge-transfer interaction with target ions. First, TiO₂ nanorods were prepared by a hydrothermal method. Vertically standing TiO₂ NRs with an average diameter of ˜200 nm and a length of ˜8 μm were successfully grown on FTO substrates, as shown schematically in FIG. 1A. A PVF-CNT mixture was then coated on a TiO₂ NR electrode by electrodeposition. The surface of CNTs was functionalized by PVF, which enables uniform distribution of PVF, high mechanical robustness, and enhanced surface area. SEM and EDS analyses revealed that PVF-CNT covered the entire exposed area of the TiO₂ nanorods, as illustrated in FIG. 1B. The (PVF-CNT)/TiO₂ photoelectrode showed an increased current density by cyclic voltammetry (CV) under illumination compared to under dark, but no peaks related to the oxidation of PVF were observed due to the predominant water oxidation reaction.

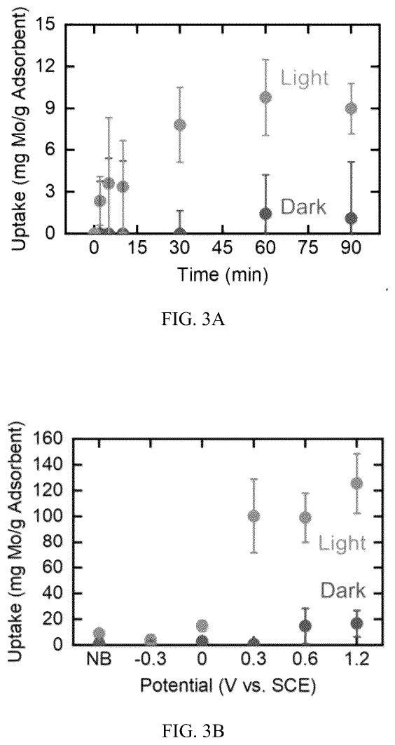

(PVF-CNT)/TiO₂ photoelectrodes were evaluated for the redox-mediated electrosorption of 2 mM of MoO₄²⁻ in DI water without supporting electrolytes under no bias condition. Interestingly, the simulated solar irradiation onto the (PVF-CNT)/TiO₂ NR electrodes induced redox-mediated adsorption of MoO₄²⁻, as illustrated in FIG. 1C. As the irradiation time increased, the uptake of MoO₄²⁻ increased and saturated at 10 mg/g Adsorbent after 60 min, shown in FIG. 3A. Upon the irradiation, the potential of the (PVF-CNT)/TiO₂ NR electrodes shifted to negative potentials and the current started to flow readily, despite no electrical bias being supplied. Without light, little to no adsorption occurred.

With a bias voltage applied, (PVF-CNT)/TiO₂ photoelectrodes exhibited higher uptake capacity than the process under no bias illumination conditions, as shown in FIG. 3B. The (PVF-CNT)/TiO₂ NR electrodes adsorbed MoO₄²⁻ under illumination at potentials higher than −0.3 V vs. SCE which is more negative than the estimated redox potential of PVF. At 0, 0.3, and 0.6 V vs. SCE under illumination, the uptake amounts were 15, 100, and 99 mg/g Adsorbent. The uptake increased significantly from 0.3 V vs. SCE close to but still lower than the redox potential. The highest uptake was achieved to be 126 mg/g Adsorbent at 1.2 V vs. SCE under illumination. Bare TiO₂ NR and (CNT-only)/TiO₂ NR electrodes showed no adsorption at 1.2 V vs. SCE under illumination, which confirms that the electrosorption was primarily driven by the PVF-functionalized film and the associated redox-process. Under dark, MoO₄²⁻ was captured only at potentials higher than 0.3 V vs. SCE, the higher potentials than the redox potential of PVF, which corresponds to the separation trends shown by not only a (PVF-CNT)/carbon paper electrode but also previous EC separation results using PVF as a redox mediator. That is, the PEC system described in this disclosure can induce the separation with no or lower bias voltages compared to the EC system.

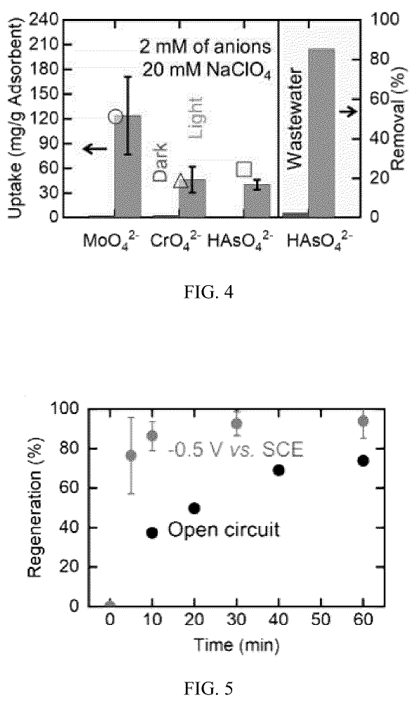

To evaluate the applicability of this exemplary PEC system to separation in a real environment, separation of MoO₄²⁻, CrO₄²⁻, and HASO₄²⁻ was conducted in the presence of 20 mM NaClO₄ as a competing ion, as shown in FIG. 4. At 0.3 V vs. SCE under illumination, (PVF-CNT)/TiO₂ photoelectrodes achieved uptakes of 124, 46, and 40 mg/g Adsorbent for Mo, Cr, and As, respectively. For Mo, the uptake amount is comparable to that obtained without NaClO₄, which implies preferable adsorption of MoO₄²⁻ vs. ClO₄⁻. The separation factors of MoO₄²⁻, CrO₄²⁻, and HAsO₄²⁻ over ClO₄⁻ were estimated to be 58.1, 23.1 and 17.6, respectively. See Table 1 below, which shows atomic proportions from x-ray photoelectron spectroscopy (XPS) analyses of heavy metal and Cl anions on (PVF-CNT)/TiO₂ photoelectrodes after PEC separation reaction at 0.3 V vs. SCE under illumination for 90 min, and also the separation factors of heavy metal anions with respect to each ClO₄⁻ and Cl⁻. It is notable that the uptake capacity of the (PVF-CNT)/TiO₂ photoelectrodes at 0.3 V vs. SCE is at a similar level to previous reports based on purely EC bias at 0.8 V vs. Ag/AgCl (0.75 V vs. SCE). Therefore, the PEC system can exhibit an uptake capacity which is comparable to that of a traditional EC system at significantly lower voltages and resulting lower electrical energy. Furthermore, the PEC system achieved 85% of removal efficiency for 1 ppm As in real secondary wastewater under illumination, as shown in FIG. 4. No decay of the current density was observed over the 6 h operation time, thus providing initial stability. The (PVF-CNT)/TiO₂ photoelectrodes also demonstrated regeneration efficiency of above 90% in 30 min at −0.5 V vs. SCE under dark, as shown in FIG. 5, which infers reversible ion adsorption/desorption properties. These small extent of un-released heavy metal oxyanions on the electrode results from the strong binding between the anions and Fc⁺ sites, a hysteresis effect that has been reported previously and that does not impact working capacity of the electrosorbent.

TABLE 1
Adsorption onto photoelectrodes after PEC separation and separation factors.

| | 20 mM NaClO₄ | | | | 20 mM NaCl | | |
|---|---|---|---|---|---|---|---|
| | Na₂MoO₄ | Na₂CrO₄ | Na₂HAsO₄ | | Na₂MoO₄ | Na₂CrO₄ | Na₂HAsO₄ |
| Metal | 51.6% | 49.1% | 43.9% | Metal | 50.7% | 37.7% | 33.8% |
| ClO₄⁻ | 8.9% | 21.3% | 24.9% | Cl⁻ | 49.3% | 62.3% | 53.0% |
| Separation | 58.1 | 23.1 | 17.6 | Separation | 10.3 | 6.1 | 6.4 |
| Factor | | | | Factor | | | |

### Investigation of Redox-Behavior of Soluble Ferrocenes Under PEC Conditions

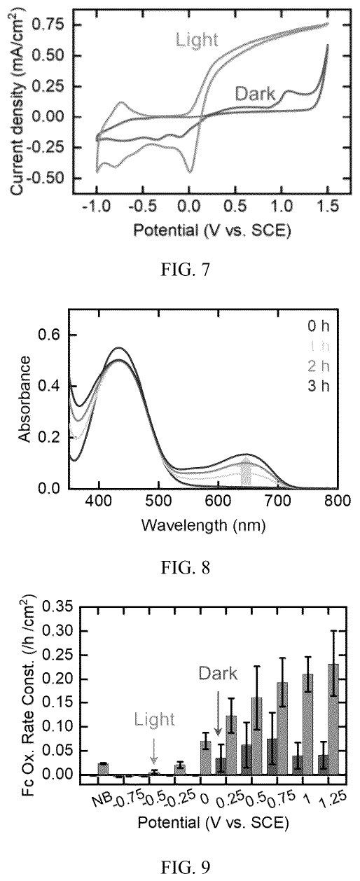

Next, the redox behavior of Fc when interacting with a TiO₂ NR electrode under different PEC conditions was investigated with water-soluble BTMAP-Fc, to track the oxidation state of the Fc redox-unit more easily. FIG. 6A is a schematic diagram of homogeneous oxidation of BTMAP-Fc in an aqueous electrolyte with a TiO₂ NR electrode, and FIG. 6B is a scanning electron microscopy (SEM) image of the TiO₂ nanorods. To avoid reduction of BTMAP-Fc⁺ occurring simultaneously on a counter electrode, a salt bridge was employed. CV was employed to study the redox behavior of BTMAP-Fc with TiO₂ NR electrodes in the salt bridge cell (FIG. 7). However, no oxidation peaks were identified from the CV curve under illumination, corresponding to the results of a heterogeneous (PVF-CNT)/TiO₂ photoelectrode. Although the onset potential shift was observed, the oxidation behavior of BTMAP-Fc could not be clearly seen in the CV curves under illumination.

However, the potential-dependent oxidation behavior of BTMAP-Fc could be confirmed by ultraviolet-visible (UV-Vis) spectroscopy. Under illumination, TiO₂ NR electrodes immersed in the BTMAP-Fc solution induced the emergence of a peak near 645 nm, which corresponds to the absorption of Fc⁺, indicating the oxidation of BTMAP-Fc to BTMAP-Fc⁺. The oxidation reaction happened even without applying a bias (FIG. 8), i.e., we observed unassisted solar-driven Fc oxidation. Under dark, the oxidation rate constant of 0.004/h/cm² is comparable to that of the natural oxidation reaction. Next, the degree of BTMAP-Fc oxidation at different potentials was traced as a function of reaction time and displayed as a rate constant in FIG. 9. Under dark, the oxidation reaction started at 0.25 V vs. SCE, which implies the onset potential for the oxidation lies between 0 and 0.25 V vs. SCE, which is consistent with the results with a carbon paper electrode. In contrast, the onset potential under illumination shifted negatively to a potential between −0.75 and −0.5 V vs. SCE, i.e., the light irradiation resulted in the oxidation at lower bias voltages not only than those under dark but also than the redox potential of BTMAP-Fc at 0.18 V vs. SCE. As the bias voltage increases, the rate constant becomes higher.

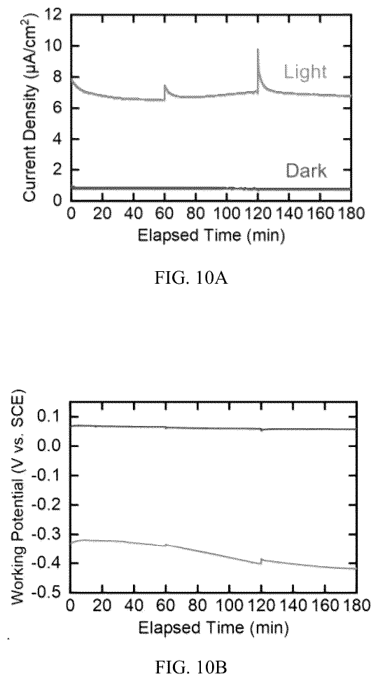

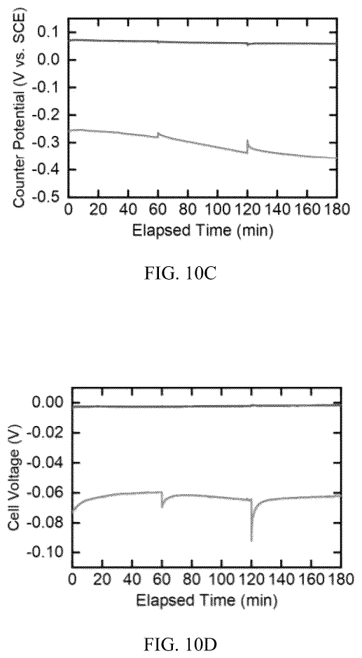

TiO₂ NR electrodes successfully convert solar energy into electrical energy for the oxidation of Fc in BTMAP-Fc, which is supported not only by the potential-dependent Fc oxidation rate constants discussed above, but also by the spontaneous current flow without electrical energy under illumination (FIG. 10A). Under no bias condition, negligible small current (in the nA range) flowed under dark, while the photocurrent density of ˜7 pA/cm² was generated by oxidation reactions of BTMAP-Fc and H₂O under illumination, which was driven by the photovoltage generated in the TiO₂ NRs (FIG. 10B).

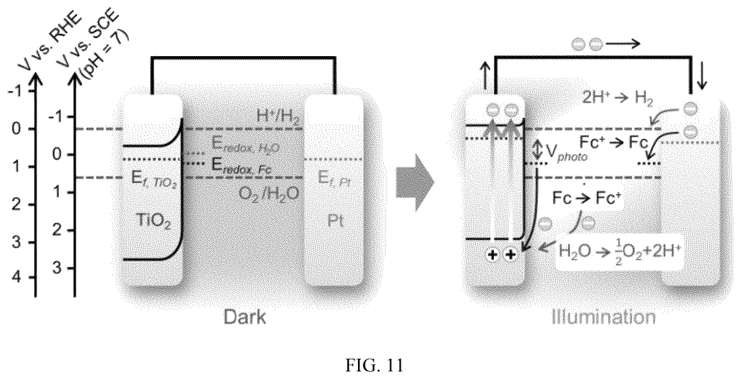

To further elucidate this effect, the intrinsic properties of the TiO₂ electrode was investigated. In the equilibrium state, the Fermi level of the TiO₂ nanorods lies at 0.07 V vs. SCE (FIGS. 10B and 11), between the redox potentials of BTMAP-Fc (0.18 V vs. SCE) and H₂O (−0.04 V vs. SCE). Also, the recorded potential of the counter electrode was 0.06-0.07 V vs. SCE (FIG. 10C), which is comparable to the Fermi level of the TiO₂ NRs, which suggests that the system was in equilibrium under dark (FIG. 11). When the TiO₂ NR electrode absorbed solar energy, however, excited electrons and holes were generated in the TiO₂ NRs, which leads to the upward-shift of the Fermi level, ascribed to an increase in a concentration of electrons in the conduction band. As a result, the potential of the TiO₂ NR electrode shifted to negative potentials by 0.4-0.5 V (FIG. 10B), which indicates the photovoltage generation. The excited holes in the valence band oxidized BTMAP-Fc and H₂O, since the valence band is more positive than the redox potential of BTMAP-Fc and the oxidation potential of H₂O. Meanwhile, the excited electrons migrated to a counter electrode to achieve thermal equilibrium. That is, the photovoltage generated in the TiO₂ NR electrode caused the negative shift of the counter potential as well (FIG. 10C) which can drive thermodynamically uphill reaction such as water-splitting reaction.

Although the counter potential was more negative than that in the equilibrium, the potential was not enough to reduce H₂O (FIGS. 10C and 10E). However, an increase in pH values after the light irradiation suggests hydrogen evolution reaction (HER), which seems to happen by the electrons having energy higher than the conduction band minimum of the TiO₂ NRs. Importantly, the cell voltage under illumination was negative, so that the oxidation is a spontaneous reaction (FIG. 10D) Consequently, the TiO₂ NR electrode can oxidize BTMAP-Fc without applying a bias voltage by utilizing solar energy, which enabled the lower oxidation onset potential than the standard Fc redox potential under dark.

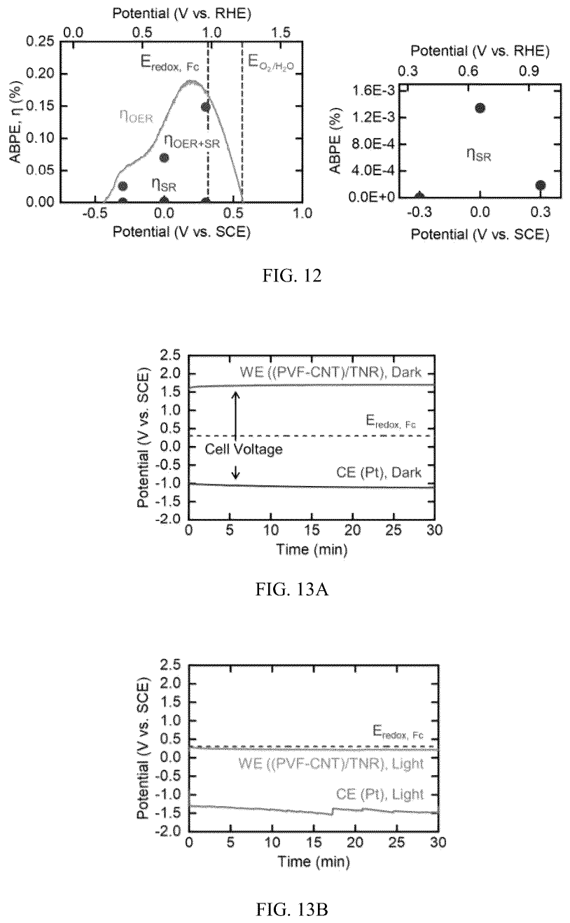

FIG. 12 shows the applied bias photon-to-current conversion efficiency (ABPE, η) of a (PVF-CNT)/TiO₂ photoelectrode. From the linear sweep voltammetry (LSV) curve, the maximum η_{OER} was determined to be 0.19% at 0.18 V vs. SCE (0.84 V vs. RHE), comparable to those reported for TiO₂ NR electrodes for water-splitting hydrogen generation reactions. The ABPE was also estimated during the ion separation. With a higher potential, the η_{OER+SR} increases. The η_{OER+SR} from chronoamperometry (CA) is lower than those from the LSV because of either the higher current density likely attributed to a hysteresis in the LSV measurement, or smaller cell voltage required for Fc oxidation (0.97 V) than that of water splitting (1.23 V). At 0.3 V vs. SCE, the η_{OER+SR} was determined to be 0.15%. However, the η_{SR} becomes lower from 0.0013 to 0.00018% when the potential changes from 0 to 0.3 V vs. SCE, while the MoO₄²⁻ uptake increases significantly. This implies that the bias voltage plays a major role in the significant increase in the uptake at 0.3 V vs. SCE under illumination. Also, the Faradaic efficiency for the separation reaction suggests that OER is the predominant reaction.

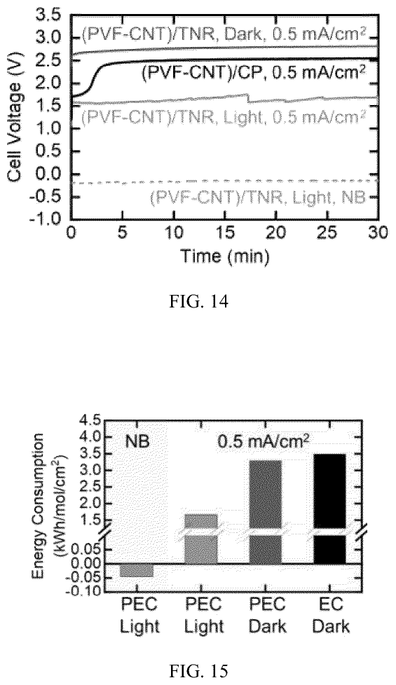

As ABPE provides a metric for the conversion efficiency for half-cell reactions, we performed an energy consumption analysis for PEC cells in separation processes. MoO₄²⁻ separation was conducted with chronopotentiometry (CP) measurements at a constant current density of 0.5 mA/cm², the current density generated during the separation of MoO₄²⁻ at 0.3 V vs. SCE (FIG. 3B) that showed a sharp increase in the uptake under illumination. For both light and dark conditions (FIGS. 13A and 13B), the Pt counter electrodes exhibited a similar level of potentials between −1.0 and −1.5 V vs. SCE. The more negative counter potentials than −0.66 V vs. SCE (0 V vs. RHE) suggest HER as a counter-reaction during the separation. On the other hand, The (PVF-CNT)/TiO₂ photoelectrodes clearly showed the difference in potentials with and without illumination. The potential changes from 1.7 V vs. SCE under dark to 0.21 V vs. SCE under illumination, which proves that a lower potential is required for separation processes in the PEC cells by utilizing solar energy. Note, the potential of 0.21 V vs. SCE is more negative than the redox potential of Fc. Consequently, the cell voltage under illumination became 1.7 V, which is a ˜40% lower cell voltage compared to dark conditions. More interestingly, the cell voltage of the PEC cells under no bias light condition is negative, meaning that the separation reaction is spontaneous, and the PEC cell generates electrical energy by converting solar energy. The cell voltage of the EC cell was measured to be 2.6 V which is close to that of the PEC cell under dark (FIG. 14).

The electrical energy consumed to generate the current density in the PEC and EC cells was compared for the 30 min electrosorption process. The PEC cell consumed 0.4 and 0.7 mWh/cm² under illumination and dark, respectively. The EC cell consumed 0.6 mWh/cm². That is, the PEC cell under illumination saved 0.3 and 0.2 mWh/cm² compared to the PEC cell under dark and the EC cell, which are 0.6 and 0.4% with respect to the power from solar illumination, respectively. Finally, the electrical energy consumed for the separation of MoO₄²⁻ was estimated for the PEC and fully EC conditions (FIG. 15). The PEC cell consumed 1.7 kWh/mol Mo/cm² under illumination, which results in an electrical energy reduction by 51.4% than that of the EC cell (3.5 kWh/mol Mo/cm²). Under fully light conditions (no-bias conditions), the PEC cell generated electrical energy by 0.046 kWh/mol Mo/cm², which was used to drive the separation.

### Experimental Procedures

Materials. Fluorine doped tin oxide (FTO) coated glass (˜7 Ω/sq, Sigma-Aldrich), titanium tetrachloride (TiCl4, 99.0%, Alfa Aesar), polyvinyl ferrocene (PVF, Polysciences Inc.), multiwalled carbon nanotube (MWCNT, Sigma-Aldrich), sodium perchlorate (NaClO₄, ≥98.0%, Sigma-Aldrich), tetrabutylammonium perchlorate (TBAClO₄, ≥99.0%, Sigma-Aldrich), sodium sulfate (Na₂SO₄, ≥99.0%, Sigma-Aldrich), titanium foil (Ti, 99.7%, Sigma-Aldrich) were purchased and used without further purification.

Growth of TiO₂ Nanorods. TiO₂ NRs were grown on FTO substrates by adapting previously reported procedures. FTO substrates (0.8×2 cm) were cleaned by ultrasonication sequentially with acetone, ethanol, and deionized (DI) water for each 5 min and then dried under a N₂ stream. The reaction solution was prepared by adding 1 mL of TiCl₄ dropwise to an HCl (30 mL) and DI (30 mL) mixture after which the solution was stirred vigorously for several hours. Then, two cleaned substrates and 15 mL of the prepared reaction solution were transferred to a 25 mL-Teflon lined autoclave. The substrates were placed by leaning their conductive side against the wall of the Teflon-lined autoclave. Subsequently, the autoclave was heated to 150° C. in an electric oven. After 6 h, the autoclave was cooled to room temperature with water flow. The samples were thoroughly rinsed with DI water and heat-treated at 500° C. for 30 min in air.

Electrodeposition of Redox Polymer on TiO₂ Electrodes. (PVF-CNT)/TiO₂ photoelectrodes were fabricated by an adapted method from previously reported techniques. First, a stock solution of PVF-functionalized CNT was prepared by dissolving 80 mg of PVF and 40 mg of MWCNT in 10 mL of chloroform, followed by sonication for 2 h in an ice bath. Then, 0.5 mL of the PVF-CNT stock solution was diluted with 4.5 mL of chloroform containing 0.5 mmol of TBAClO₄, and sonicated for an additional 1 h. Electrodeposition of PVF-CNT on TiO₂ NR electrodes was then carried out in a two-electrode cell, where a counter electrode was Ti foil, under a constant current of 62.5 pA/cm² with stirring under dark until 100 mC/cm² of charges passed (1600 s). To reduce ferrocenium oxidized from ferrocene during the electrodeposition reaction, a constant potential of −1 V vs. SCE was applied to the prepared (PVF-CNT)/TiO₂ NR electrodes for 30 min in a three-electrode cell containing a saturated calomel electrode (SCE, V=0.244 V vs. NHE at 25 Saturated KCl, Basi) and a platinum wire (Pt, 99.95%, Basi) as a reference electrode and a counter electrode, respectively, with 100 mM NaClO₄ in DI water. After which the prepared (PVF-CNT)/TiO₂ photoelectrodes were dried and stored without exposure to light for further characterizations.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

In addition to the features mentioned in each of the independent aspects enumerated above, some examples may show, alone or in combination, the optional features mentioned in the dependent aspects and/or as disclosed in the description above and shown in the figures.

What is claimed is:

1. A redox-functionalized photoelectrode comprising:
a photoactive structure comprising a semiconductor; and
a redox polymer coated on the photoactive structure,
wherein a valence band potential of the semiconductor is more positive than a redox potential of the redox polymer.

2. The redox-functionalized photoelectrode of claim 1, wherein the semiconductor is selected from the group consisting of: BiVO₄, Fe₂O₃, CdS, ZnO, and TiO₂, and/or wherein the redox polymer comprises a metallopolymer selected from the group consisting of: polyvinyl ferrocene (PVF), polyferrocenylmethyl methacrylate (PFMAA), and poly(3-ferrocenylpropyl methacrylamide) (PFPMAm).

3. The redox-functionalized photoelectrode of claim 1, wherein the redox polymer is selective toward inorganic oxyanions (MO₄²⁻, M=metal) and carboxylates.

4. The redox-functionalized photoelectrode of claim 1, wherein the photoactive structure comprising the semiconductor has a non-planar morphology.

5. The redox-functionalized photoelectrode of claim 1, wherein the photoactive structure comprises surface protrusions, surface indentations, surface roughness, rods, wires, fibers, pellets, beads, particles, a porous film, a porous scaffold, and/or a permeable membrane.

6. The redox-functionalized photoelectrode of claim 1, wherein the photoactive structure is self-supporting.

7. The redox-functionalized photoelectrode of claim 1, further comprising a substrate supporting the photoactive structure.

8. A photoelectrochemical system for separation of ionic species from a liquid to be treated, the photoelectrochemical system comprising:
a redox-functionalized photoelectrode comprising:
a photoactive structure comprising a semiconductor; and
a redox polymer coated on the photoactive structure; and
a light source for illuminating the photoactive structure.

9. The photoelectrochemical system of claim 8, wherein a valence band potential of the semiconductor is more positive than a redox potential of the redox polymer.

10. The photoelectrochemical system of claim 8, further comprising a counter electrode spaced apart from the redox-functionalized photoelectrode.

11. The photoelectrochemical system of claim 10, further comprising a voltage source electrically connected to the photoelectrode and the counter electrode.

12. The photoelectrochemical system of claim 8, further comprising a vessel configured to hold the liquid to be treated.

13. A photoelectrochemical method for separating targeted ionic species from a liquid, the photoelectrochemical method comprising:
exposing a redox-functionalized photoelectrode to a liquid to be treated, the redox-functionalized photoelectrode comprising:
a photoactive structure comprising a semiconductor; and
a redox polymer coated on the photoactive structure, the redox polymer comprising a redox-active group;
during the exposure, illuminating the redox-functionalized photoelectrode with light having a wavelength greater than a bandgap of the semiconductor,
whereby oxidation of the redox-active group occurs and targeted ionic species are removed from the liquid by adsorption onto the redox polymer.

14. The photoelectrochemical method of claim 13, further comprising applying a bias voltage to the redox-functionalized photoelectrode during the illumination.

15. The photoelectrochemical method of claim 13, wherein a bias voltage is not applied during the illumination.

16. The photoelectrochemical method of claim 13, wherein exposing the redox-functionalized photoelectrode to the liquid comprises immersing the redox-functionalized photoelectrode in the liquid in a batch process.

17. The photoelectrochemical method of claim 13, wherein exposing the redox-functionalized photoelectrode to the liquid comprises immersing the redox-functionalized photoelectrode in the liquid in a continuous flow process.

18. The photoelectrochemical method of claim 17, wherein the redox-functionalized photoelectrode is positioned in a flow-through configuration with respect to flow of the liquid, or
wherein the redox-functionalized photoelectrode is positioned in a flow-by configuration with respect to flow of the liquid.

19. The photoelectrochemical method of claim 13, wherein the light includes solar radiation.

20. The photoelectrochemical method of claim 13, wherein the light includes artificial light.
